(19) United States
(12) Patent Application Publication
(10) Pub. No.: US 2017/0312765 A1
(43) Pub. Date: Nov. 2, 2017

(54) APPARATUS FOR THE EROSIVE MACHINING AND/OR CLEANING OF A MATERIAL OR A WORKPIECE SURFACE BY MEANS OF AT LEAST ONE HIGH-PRESSURE FLUID JET, AND METHOD FOR OPERATING SUCH AN APPARATUS

(71) Applicant: Robert Bosch GmbH, Stuttgart (DE)

(72) Inventor: Uwe Iben, Khimki (RU)

(21) Appl. No.: 15/523,552

(22) PCT Filed: Oct. 16, 2015
(86) PCT No.: PCT/EP2015/073981

§ 371 Date: May 1, 2017

(30) Foreign Application Priority Data
Oct. 31, 2014 (DE) 10 2014 222 299.0

(51) Int. Cl. B05B 1/08; B26F 3/00; B24C 5/02; F16K 31/40; B08B 3/02

(52) U.S. Cl. CPC B05B 1/083; F16K 31/406; B08B 3/02; B24C 5/02; B26F 3/004

(57) ABSTRACT

The invention relates to a device for the erosive processing and/or the cleaning of a material or of a material surface by means of at least one high-pressure fluid jet, comprising a nozzle (1) for outputting a high-pressure fluid jet and an apparatus (2) arranged upstream of the nozzle (1) for producing a pulsed high-pressure fluid jet, wherein the apparatus (2) comprises at least one valve (3). According to the invention, the valve (3) is designed as a servo valve and has an axially movable valve piston (4) for connecting a valve feed (5) to a valve outlet (6) such that the flow through the valve (3) can be specified by means of the axial position of the valve piston (4). The invention further relates to a method for operating a device according to the invention.

### BACKGROUND OF THE INVENTION

The invention relates to an apparatus for the erosive machining and/or cleaning of a material or a workpiece surface by means of at least one high-pressure fluid jet. Furthermore, the invention relates to a method for operating such an apparatus.

The laid-open specification DE 10 2013 201 797 A1 discloses an apparatus for the water-jet cutting of materials, for example steel, stone, glass, tiles, ceramic, foodstuffs or plastics, which comprises a high-pressure pump and a nozzle. The high-pressure pump serves to generate a high-pressure fluid jet, in particular a high-pressure water jet, to be output via the nozzle. In order to keep the drive power of the high-pressure pump small and allow the creation of complex three-dimensional structures within the materials by means of the high-pressure fluid jet, said document proposes that the apparatus furthermore have a device for generating fluid pulses emerging through the nozzle, wherein the fluid pulses are configured to remove a predetermined quantity of particles from the material. Via the specified apparatus, a discontinuous fluid jet, i.e. in particular a periodically interrupted fluid jet, is intended to be able to be generated, which has a high removal effect at a comparatively low delivery pressure of the high-pressure pump. The bursts or fluid pulses at a deliberate frequency result in a self-reinforcing effect, i.e. in improved material removal in the cutting edge, since the latter is not clogged by the fluid jet. At the same time, the fluid pulses allow the cutting and/or introduction of a three-dimensional geometry into the material. In a preferred configuration of the apparatus, the device for generating the fluid pulses comprises at least one valve, which is intended to be configured in the manner of an injection valve of an internal combustion engine. In order to actuate the valve, preferably a solenoid actuator or piezo actuator is provided.

Proceeding from the abovementioned prior art, the present invention is based on the object of specifying an apparatus for the erosive machining and/or cleaning of a material or a workpiece surface, which has an even lower energy requirement. Furthermore, a method for the energy-saving operation of the apparatus is intended to be specified.

### SUMMARY OF THE INVENTION

The proposed apparatus is able to be used for the erosive machining and/or cleaning, in particular pulsed cleaning, of a material or a workpiece surface by means of at least one high-pressure fluid jet. In order to output a high-pressure fluid jet, the apparatus comprises a nozzle, upstream of which, in order to generate a pulsed high-pressure fluid jet, a device having at least one valve is connected. According to the invention, the valve is configured as a servo valve and has an axially displaceable valve piston for connecting a valve inlet to a valve outlet such that the flow rate through the valve is able to be defined via the axial position of the valve piston.

Embodied as a servo valve, the valve of the device for generating a pulsed high-pressure fluid jet requires very little switching energy, in particular compared to an injection valve of an internal combustion engine. This in turn leads to a much lower energy demand of the apparatus and of the cutting or cleaning process. At the same time, a complex geometry can be introduced into the material or the workpiece and/or effective cleaning of the particular surface can be achieved via the pulsed high-pressure fluid jet.

The pulsed high-pressure fluid jet is preferably composed of a continuously generated jet part and a discontinuously generated jet part. To this end, the flow rate through the valve is increased and reduced at particular time intervals. Alternatively, it is also possible for a purely discontinuously generated fluid jet, without a continuous jet part, to be used as the pulsed high-pressure fluid jet.

In contrast to cutting by means of a continuous high-pressure fluid jet, when cutting by means of a pulsed high-pressure fluid jet, a very clean cutting edge can be achieved even in the case of materials such as carbon-fiber-reinforced or glass-fiber-reinforced plastics. This has hitherto always proven difficult. Furthermore, the proposed apparatus can be used for cutting many further materials, for example metal, ceramic, stone or wood. As a result of the self-reinforcing effect of the fluid pulses, the use of abrasive media can be dispensed with. This in turn has the result that wear in the region of the nozzle is reduced, the service life of the apparatus is increased and the operating costs are heavily reduced.

The valve, embodied as a servo valve, of the device for generating a pulsed high-pressure fluid jet at the same time forms a gate valve on account of the axially displaceable valve piston. Specifically, the flow rate through the valve is defined by the axial position of the valve piston. This means that, depending on the axial position of the valve piston, a particular flow area is opened up or closed, wherein preferably the valve piston can take up any desired position between a closed position and a maximum open position such that the flow rate is continuously variable.

As a gate valve, the valve of the device is not capable of complying with such high demands in regard to sealing as for example an injection valve, configured as a poppet valve, of an internal combustion engine. However, this is also not necessary, since a jet interruption of about 95% is considered sufficient.

Tests have shown that, with the proposed apparatus, up to 80% energy can be saved when cutting carbon-fiber-reinforced plastics. In addition, clean cutting edges are achieved.

According to a preferred embodiment of the invention, the valve piston bounds a control chamber that is hydraulically connected to the valve inlet and is able to be relieved via a pilot valve. Accordingly, with the pilot valve closed, the same hydraulic pressure prevails in the control chamber as in the valve inlet. If the pilot valve is opened, the pressure in the control chamber drops, and so the valve piston is displaced in the direction of the control chamber via the higher pressure in the valve inlet and the flow rate through the valve changes. The axial displacement of the valve piston is in this case preferably brought about only via the prevailing hydraulic pressure conditions, such that the use of a spring urging the valve piston in the opening or closing direction can be dispensed with. Accordingly, for the axial displacement of the valve piston, no actuators for overcoming the spring force of a spring have to be provided, with the result that the energy demand of the apparatus is reduced further.

Furthermore preferably, the valve piston has at least one duct for hydraulically connecting the control chamber to the valve inlet. The at least one duct can be realized for example by an axial bore in the valve piston. Furthermore, it is also possible for a plurality of such bores to be provided. Preferably, the diameter of the at least one duct is selected such that the total effective flow area of the one duct or of the plurality of ducts is less than the effective flow area that is able to be opened up by the pilot valve. This ensures that the pressure in the control chamber drops quickly with the pilot valve open and the flow rate through the valve increases in a pulsed manner.

Advantageously, the valve piston is embodied as a stepped piston and has a first end face, facing the valve inlet, which is smaller than a second end face, facing away from the valve inlet, for bounding the control chamber. The two end faces represent hydraulically effective control faces which, depending on the respectively selected area ratio, allow pressure amplification. The force required for the axial displacement of the valve piston is accordingly reduced even further, and so a valve with high dynamics is created.

It is furthermore proposed that the pilot valve be electromagnetically or piezoelectrically actuable. This means that the pilot valve comprises a solenoid actuator or a piezo actuator. Particularly preferably, the pilot valve is configured as a solenoid valve, since such a valve is easy and cost-effective to produce.

A development of the invention proposes that the device for generating a pulsed high-pressure fluid jet comprise a fluid store for supplying the valve with fluid. Fluid can be temporarily stored in the fluid store in order to allow the generation of a pulsed high-pressure fluid jet with the device being continuously supplied with fluid. The structural design of the device can be simplified in this way.

Further preferably, in order to deliver the fluid at a high pressure, a high-pressure pump is provided, which is a constituent part of the device or is connected upstream of the device. The high-pressure pump serves to compress the fluid and also to deliver the compressed fluid in the direction of the nozzle. Preferably, the high-pressure pump is able to be driven via an electric motor. Such a motor is compact and allows the delivery rate of the high-pressure pump to be set precisely.

The fluid delivered at high pressure is preferably water. The use of water as a cutting medium contributes to high environmental friendliness of the apparatus. This means that the apparatus is able to be operated in an environmentally friendly manner.

In the method furthermore proposed for operating an apparatus according to the invention, in order to generate a pulsed high-pressure fluid jet, the valve of the device is actuated in a clocked manner. The clock frequency is preferably 40 to 200 Hz. The comparatively high frequency of the fluid pulses results in an improvement in the cutting process, in particular when cutting carbon-fiber-reinforced plastics. Tests have shown that, with a simultaneously considerably reduced energy requirement, clean cutting edges are achievable. The working pressure can be between 500 and 1500 bar at the abovementioned clock frequency. For specific applications, for example for cutting particularly strong materials and/or for great cutting depths, the working pressure can be up to 4000 bar.

### BRIEF DESCRIPTION OF THE DRAWINGS

A preferred embodiment of the invention is described in more detail in the following text with reference to the appended drawings, in which:

FIG. 1 shows a schematic illustration of an apparatus according to the invention according to a preferred embodiment of the invention, and

FIG. 2 shows a schematic longitudinal section through a valve of the apparatus in FIG. 1.

### DETAILED DESCRIPTION

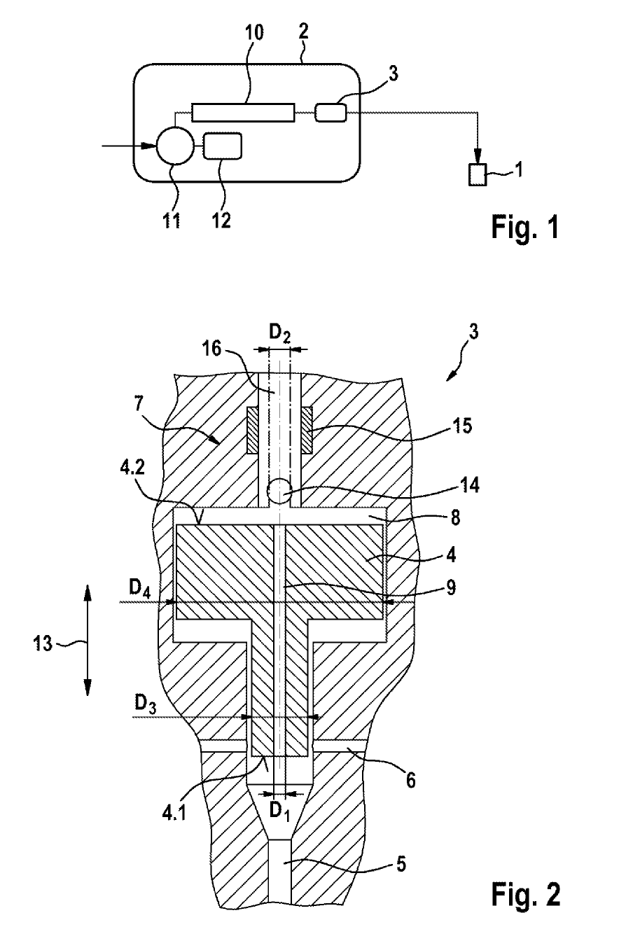

The illustration in FIG. 1 is limited to the essential components of an apparatus according to the invention. These are a nozzle 1 for outputting a high-pressure fluid jet and a device 2 for generating a pulsed high-pressure fluid jet. To this end, the device 2 comprises a valve 3, which is embodied as a servo valve and is described in more detail in the following text in conjunction with FIG. 2. Connected upstream of the valve 3 is a fluid store 10, to which fluid under high pressure, in the present case water, is able to be fed via a high-pressure pump 11. The fluid store 10 and the high-pressure pump 11 are, like the valve 3, constituent parts of the device 2. The latter furthermore comprises an electric motor 12 for driving the high-pressure pump 11. The high-pressure pump 11 can be driven continuously via the electric motor 12, such that fluid is fed continuously to the fluid store 10.

FIG. 2 illustrates a preferred configuration of the valve 3 of the device 2. The valve 3 is embodied as a servo valve and comprises a valve piston 4, displaceable back and forth in an axial direction, for connecting a valve inlet 5 to a valve outlet 6. The direction of movement of the valve piston 4 is indicated by the arrow 13. The valve outlet 6 is formed in the present case by two mutually opposite, radially extending bores, while the valve inlet 5 is arranged axially. Depending on the axial position of the valve piston 4, the bores that serve as the valve outlet 6 are accordingly closed or at least partially opened up, such that the flow rate through the valve 3 is able to be determined thereby.

The axial position of the valve piston is hydraulically controllable. To this end, the valve piston 4 has a first end face 4.1, which faces the valve inlet 5 and is subjected to inlet pressure. A second end face 4.2, facing away from the valve inlet 5, of the valve piston 4 bounds a control chamber 8 which is able to be relieved via a pilot valve 7. As long as the pilot valve 7 is closed, inlet pressure likewise prevails in the control chamber 8, since a duct 9, which hydraulically connects the control chamber 8 to the valve inlet 5, is formed in the valve piston 4. The diameter D₁ of the duct 9 is selected to be smaller than the diameter D₂ of an outflow opening 16 that is closable via a valve closing element 14 of the pilot valve 7, such that, with the pilot valve 7 open, the pressure in the control chamber 8 drops reliably and quickly. In a supporting manner, the area ratio of the two end faces 4.1 and 4.2 of the valve piston 4 is selected such that the hydraulic pressure force that brings about the axial displacement of the valve piston 4 acts in a reinforced manner. To this end, the valve piston 4 is embodied in a stepped manner, wherein the end face 4.1 having the diameter D₃ is much smaller than the end face 4.2 having the diameter D₄.

The pilot valve 7 is actuated electromagnetically in the present case. To this end, the pilot valve 7 comprises an electromagnet 15, via the magnet force of which it is possible to act on an armature (not illustrated), capable of reciprocating movement, coupled to the valve closing element 14. If the armature lifts, the valve closing element 14 is capable of opening. Via the outflow opening 16, fluid then flows out of the control chamber 8, resulting in a pressure drop in the control chamber 8. The higher inlet pressure present at the end face 4.1 thus results in an axial displacement of the valve piston 4 in the direction of the pilot valve 7, such that a greater flow area of the valve outlet 6 is opened up and the flow rate through the valve 3 is increased. In this way, a fluid pulse or a pulsed high-pressure fluid jet is generated.

The invention is not limited to the exemplary embodiment illustrated. Rather, modifications are possible which relate in particular to the specific configuration of the valve 3. Furthermore, the working pressure can vary. The latter depends in particular on the working medium, which is preferably water. However, oil/water emulsions can also be used as the working medium.

1. An apparatus for the erosive machining and/or cleaning of a material or a workpiece surface by means of at least one high-pressure fluid jet, the apparatus comprising a nozzle (1) for outputting a high-pressure fluid jet, and a device (2), connected upstream of the nozzle (1), for generating a pulsed high-pressure fluid jet, wherein the device (2) comprises at least one valve (3) that is configured as a servo valve and that has an axially displaceable valve piston (4) for connecting a valve inlet (5) to a valve outlet (6) such that a flow rate through the valve (3) is defined via an axial position of the valve piston (4).

2. The apparatus as claimed in claim 1, characterized in that the valve piston (4) bounds a control chamber (8) that is configured to be relieved via a pilot valve (7) and that is hydraulically connected to the valve inlet (5) such that, with the pilot valve (7) closed, the same hydraulic pressure prevails in the control chamber (8) as in the valve inlet (5).

3. The apparatus as claimed in claim 2, characterized in that the valve piston (4) has at least one duct (9) for hydraulically connecting the control chamber (8) to the valve inlet (5).

4. The apparatus as claimed in claim 1, characterized in that the valve piston (4) is embodied as a stepped piston and has a first end face (4.1), facing the valve inlet (5), which is smaller than a second end face (4.2), facing away from the valve inlet (5), for bounding the control chamber (8).

5. The apparatus as claimed in claim 2, characterized in that the pilot valve (7) is electromagnetically or piezoelectrically actuable.

6. The apparatus as claimed in claim 1, characterized in that the device (2) comprises a fluid store (10) for supplying the valve (3) with fluid.

7. The apparatus as claimed in claim 1, characterized in that, in order to deliver the fluid at a high pressure, the apparatus comprises a high-pressure pump (11) which is a constituent part of the device (2) or is connected upstream of the device (2).

8. A method for operating an apparatus as claimed in claim 1, characterized in that, in order to generate a pulsed high-pressure fluid jet, the valve (3) of the device (2) is actuated in a clocked manner.

9. A method for operating an apparatus as claimed in claim 1, characterized in that, in order to generate a pulsed high-pressure fluid jet, the valve (3) of the device (2) is actuated in a clocked manner with a clock frequency of 40 to 200 Hz.

10. The apparatus as claimed in claim 2, characterized in that the valve piston (4) has at least one duct (9) for hydraulically connecting the control chamber (8) to the valve inlet (5), wherein a total effective flow area of the one duct (9) or of the plurality of ducts (9) is less than an effective flow area that is able to be opened up by the pilot valve (7).

11. The apparatus as claimed in claim 1, characterized in that, in order to deliver the fluid at a high pressure, the apparatus comprises a high-pressure pump (11) which is a constituent part of the device (2) or is connected upstream of the device (2), wherein the high-pressure pump (11) is configured to be driven via an electric motor (12).
